(19) United States
(12) Patent Application Publication
(10) Pub. No.: US 2006/0266779 A1
(43) Pub. Date: Nov. 30, 2006

(54) FOLD-UP TRAY

(75) Inventors: Eric Mozer, Rochester, MI (US); Roger Catron, Washington, MI (US); John Frederick, Romeo, MI (US); Aaron Delong, Oxford, MI (US); Roland Oludare Adesanya, Flint, MI (US); Patrick Ayoub, Bloomfield Hills, MI (US)

Correspondence Address: ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 10/908,708

(22) Filed: May 24, 2005

(51) Int. Cl. B60R 7/00; B60R 11/00; B60R 9/00

(52) U.S. Cl. 224/543; 224/524; 224/277

(57) ABSTRACT

A fold-up tray for use in a vehicle is provided. The tray includes a top surface, a first section, a second section and a hinge. The first section includes a first portion of the top surface. The second section includes a second portion of the top surface. The hinge connects the first section and the second section, thereby affording an increased working surface when both portions of the tray are unfolded while also providing a stowable working surface when both portions of the tray are folded. In one embodiment, the hinge is a living hinge.

### TECHNICAL FIELD

The present invention relates generally to a usable surface for use in a vehicle and more particularly to a folding tray releasably securable to a bolster area of the vehicle.

### BACKGROUND OF THE INVENTION

Clipboards or other usable surfaces are well known and useful in a variety of applications in which a portable writing board is desired. The backseat occupants of a vehicle may use the clipboard for coloring or for doing other paperwork. Typically, such clipboards are lost or misplaced when used in the vehicle. Moreover, such boards are bulky or awkward for storing and if stored may consume excessive interior space.

Accordingly, it would be desirable to have a tray that is conveniently accessible to a vehicle occupant, saves space when stowed, is stowable within the vehicle, is aesthetically pleasing or provides an expanded working surface.

### SUMMARY OF THE INVENTION

A fold-up tray for use in a vehicle is provided. The tray includes a top surface, a first section, a second section and a hinge. The first section includes a first portion of the top surface. The second section includes a second portion of the top surface. The hinge connects the first section and the second section, thereby affording an increased working surface when both portions of the tray are unfolded while also providing a stowable working surface when both portions of the tray are folded.

In one embodiment of the present invention, the tray advantageously provides a bi-fold clipboard that may be folded and fastened for storage into a panel or bolster area of a vehicle.

In another embodiment of the present invention, the tray advantageously uses a living hinge to expand the useable surface while at the same time providing a folding capability in order to reduce the storage area for stowing the tray in the vehicle.

Other aspects and advantages of the present invention will become apparent upon the following detailed description and appended claims, and upon reference to the accompanying drawings.

### BRIEF DESCRIPTION OF THE DRAWINGS

FIG. 1 is a perspective view of an automotive vehicle using a fold-up tray of the present invention to advantage.

FIG. 2 is an illustrative view of the fold-up tray being used to advantage with the bolster area of the vehicle shown in FIG. 1.

FIG. 3 is a partial perspective view of the fold-up tray of the present invention.

FIG. 4 is an illustrative view of the fold-up tray being unfolded.

FIG. 5 is a perspective view of the fold-up tray in an unfolded configuration.

FIG. 6 is an illustrative view of the fold-up tray being used to advantage in another embodiment of the bolster area of a vehicle.

FIG. 7 is a top cross-sectional view of the fold-up tray being used to advantage in FIG. 6.

FIG. 8 is an illustrative view of a second embodiment of a fold-up tray for a bolster area being used to advantage in a vehicle.

FIG. 9 is the fold-up tray of FIG. 8 in a deployed position.

FIG. 10 is the fold-up tray of FIG. 8 in an unfolded position.

FIG. 11 is the fold-up tray of FIG. 8 in an adjusted position.

### DESCRIPTION OF THE PREFERRED EMBODIMENT(S)

Throughout the figures and in the views, common elements are labeled with the same reference number. The common element may also include an additional number indicating that it is a particular type, kind or style of element for the embodiment presented. The reference numbers indicating a particular type, kind or style of element are not intended to be limiting, and are intended to help the reader in understanding the different embodiments presented in this invention.

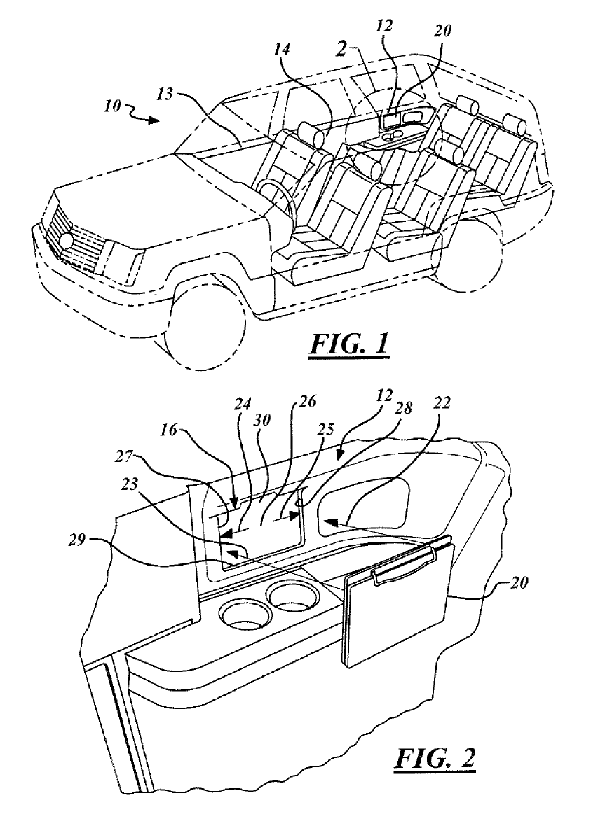

In accordance with the present invention, FIG. 1 shows a perspective view of an automotive vehicle 10 using a fold-up tray 20 to advantage. The automotive vehicle 10 includes a front door panel 13, a passenger door panel 14, and a right side panel or bolster area 12. In this embodiment, the Fold-up tray 20 is stored in a folded position in the right bolster area 12. However, it is recognized that the fold-up tray 20 may be used with or upon other areas of the vehicle including, for example, the door panels, the bolster areas and the seat backs.

FIG. 2 shows an illustrative view of the fold-up tray 20 being used to advantage with the bolster area 12 of the vehicle 10 shown in FIG. 1. The fold-up tray 20 is releasably attachable to the bolster area 12 for storage when not in use. Illustratively, the fold-up tray 20 may be releasably inserted as indicated by the arrows 22, 23 into a storage location 16 on the bolster area 12. The fold-up tray 20 is held in position on the storage location 16 of the bolster area 12 by the interference fit designed into the storage location 16. The interference fit allows for a snap fit engagement or disengagement with the storage location 16 as indicated by the arrows 24, 25. While the insertion as indicated by arrows 22, 23 allows for a particular attachment, it is recognized that the fold-up tray 20 may be inserted in a number of ways or directions depending upon the particular attachment method chosen for storing the fold-up tray 20 within the storage location 16 of a vehicle 10.

The storage location 16 of the bolster area 12 of this embodiment includes a back wall 26, side lips 27, 28 and a lower lip 29. A recess 30 is included in the back wall 26 to facilitate removal of the fold-up tray 20 from the bolster area 12 by the user. The fold-up tray 20, when stowed, rests upon the lower lip 29 and is held between the two side lips 27, 28 of the storage location 16. Typically, although not necessary, the bolster area 12 is formed from a single material piece in which the storage location 16 is formed. The storage location 16 may be designed so as to provide a flush mounting of the fold-up tray 20 when stowed and an aesthetically pleasing integrated surface when the fold-up tray is removed. The material used for constructing the bolster area or the fold-up tray may be plastic or any other suitable material combination.

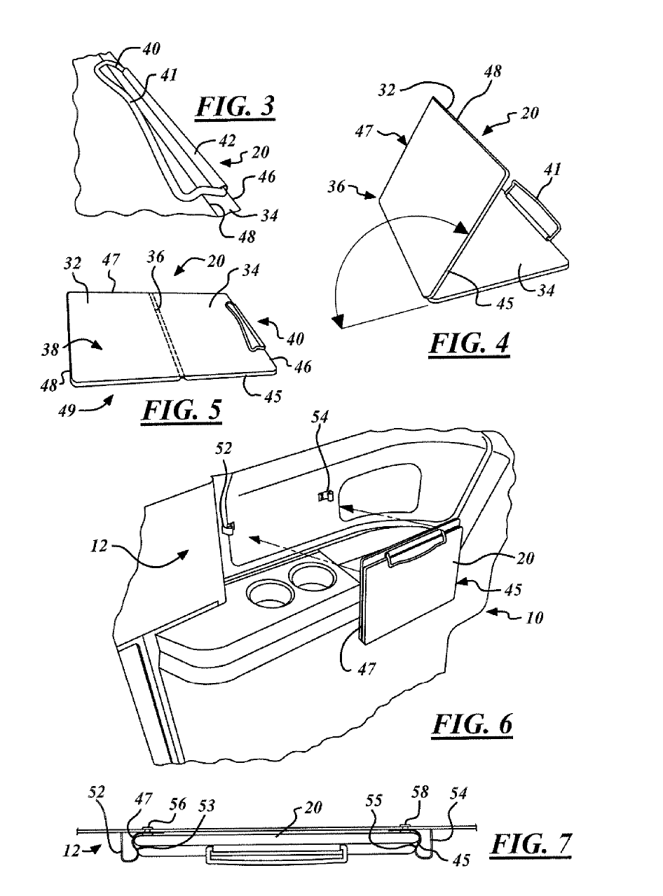

The fold-up tray 20 of the present embodiment is best described with reference to FIGS. 3, 4 and 5. FIG. 3 shows a partial perspective view of the fold-up tray 20. FIG. 4 shows an illustrative view of the fold-up tray 20 being unfolded. FIG. 5 shows a perspective view of the fold-up tray 20 in an unfolded configuration. The fold-up tray 20 includes a top surface 38 having a first section 32 and a second section 34, the sections 32, 34 being divided by a living hinge 36. The top surface 38 provides a usable area or writing surface when the sections 32, 34 are unfolded as shown in FIG. 5. The top surface 38 is not useable when the sections 32, 34 are folded one onto the other as shown in FIG. 3, but provides for a reduced size being more preferable for storing as described above. When the top surface 38 is unfolded, the sections 32, 34 together with the living hinge 36 provides for a surface 38 that is substantially planar and continuous.

The fold-up tray 20 also has a lower surface 49 and outer edges 45, 46, 47, 48.

Optionally, other types of hinges may be used. For example the hinge might be a piano hinge, which would also allow for the compact storage of the tray and still provide the substantially planar surface. Optionally, to provide for a continuous surface where the hinge creates a void or other form of discontinuity across the usable surface, additional material layers may be used upon the top surface of the tray to bind the sections together over the hinged area.

The fold-up tray 20 includes a spring-loaded clip 40. The clip is attached to the second section 34 of the tray 20. The clip 40 includes a wire 41, a housing 42 and a spring (not shown). The spring preloads the wire 41 within the housing 42 so that the wire 41 may releasably load the second section 34 of the tray 20. The wire 41 may be used to secure user-selected materials when the tray 20 is in an unfolded configuration or may hold the two sections of the tray 20 together when folded. The clip 40 also holds the tray 20 in a folded configuration that facilitates storage into the bolster area 12 of a vehicle 10. The clip 40 may be constructed of various materials, including without limitation, metal, plastic, or any combination thereof. The clip 40 may also be constructed from various material processes, including injection molding or stamping each part, for example.

Optionally, the fold-up tray 20 might not include a clip.

Optionally, the fold-up tray 20 may include any other type of clip or binding device used for the retention of user selected materials or the like.

FIG. 6 shows an illustrative view of the fold-up tray 20 being used to advantage in another embodiment of the bolster area 12 of a vehicle 10. The bolster area 12 of this embodiment includes a first hook 52 and a second hook 54 for receiving a fold-up tray. The hooks 52, 54 are attached to the bolster area by rivets 56, 58 or other suitable fastener. The hooks 52, 54 oppositely oppose each other and are separated by a sufficient distance to retentively receive the tray in a releasably securable fashion.

FIG. 7 shows a top cross-sectional view of the fold-up tray 20 being used to advantage in FIG. 6. The outer edges 45, 47 of the tray 20 releasably engage the hook surfaces 55, 53, respectively, of the hooks 54, 52. The hook surfaces 55, 53 spring out to allow for the engagement and disengagement of the tray 20 to the vehicle 10.

The hooks 54, 52 are made from spring steel. Optionally, the hooks may be formed integrally with the bolster area using a suitable material, thus eliminating the need for the rivets to attach the hooks to the bolster area.

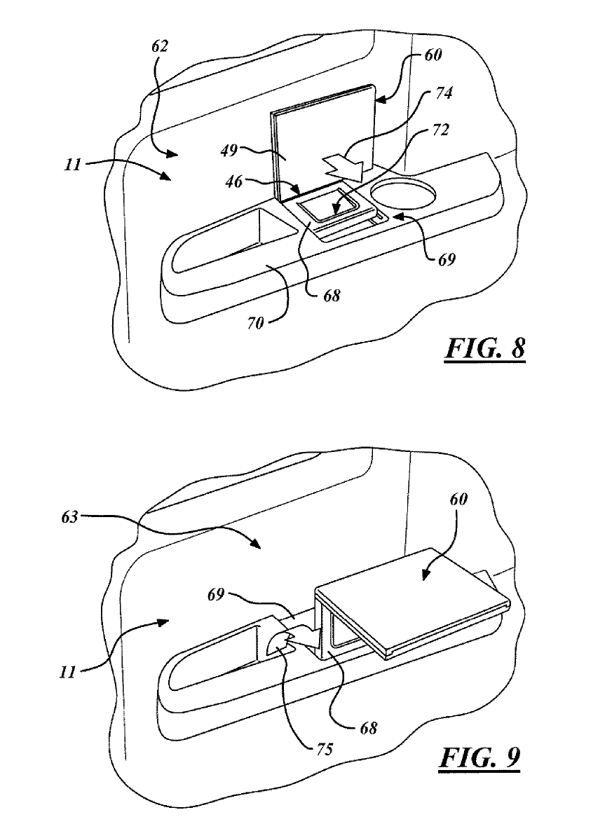

FIG. 8 shows an illustrative view of a second embodiment of a fold-up tray 60 for a bolster area 11 being used to advantage in a vehicle 10. The fold-up tray 60 is shown here in a stowed position 62. The lower surface 49, near the outer edge 46, of the tray 60 is positionably connected to a leg 68. The leg 68 is positionably connected to an armrest 70 of the bolster area 11 and includes a pivotal slide (not shown) and a handle 72. The leg 68 is flush mounted within a pocket 69 of the armrest 70, whereby the leg 68 may be positioned outward by a user pulling upon the handle 72 in the direction of arrow 74.

The leg 68 may then be rotated 75 into the locked or deployed position 63 as shown in FIG. 9. FIG. 9 shows the fold-up tray 60 of FIG. 8 in a deployed position 63. In the deployed position 63, the leg 68 is releasably locked into place by a securing mechanism (not shown). A person of skill in the art will recognize that the leg 68 may be secured to the armrest 70 by a lever, a joint, a linkage and/or a pin as an example, without limitation. Moreover, it is recognized that the leg 63, which supports the tray 60, may be secured to the bolster area 11 in other ways and need not be secured to the armrest 70.

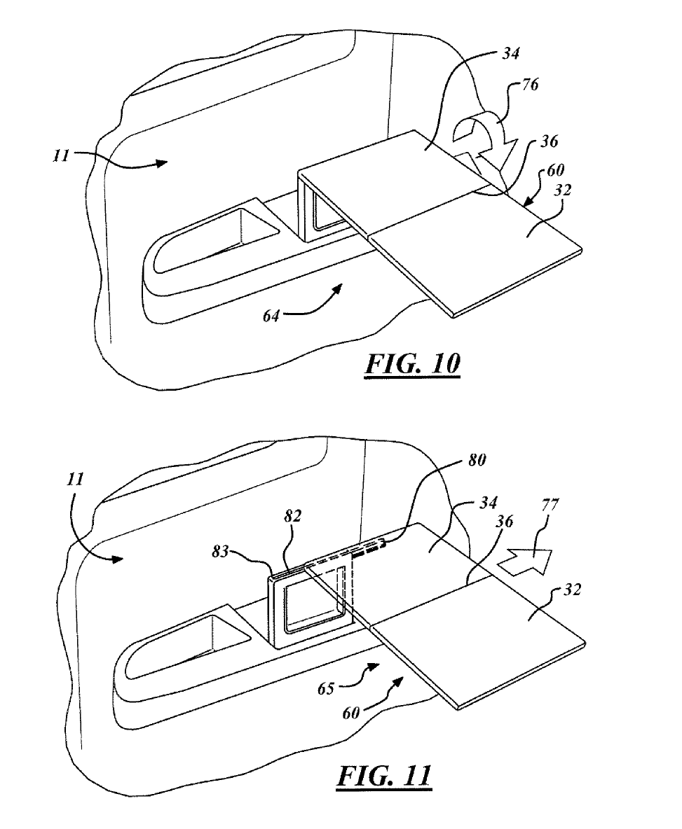

After the leg 68 is secured in the deployed position 63, the tray 60 may be used to advantage in either the folded or unfolded position. FIG. 10 shows the fold-up tray 60 of FIG. 8 in an unfolded position 64. The tray 60 may be unfolded as is indicated by the arrow 76.

After the leg 68 is secured in the deployed position 63, the tray 60 may be adjusted. FIG. 11 shows the fold-up tray 60 of FIG. 8 in an adjusted position 65. The tray 60 may be linearly positioned fore or aft as indicated by arrow 77.

As mentioned above, the tray 60 is connected to the leg 68. In this embodiment the tray 60 includes a slide rail 80 that is positionably connected to a top edge 83 in a slide slot 82 of the leg 68. The tray 60 may also be detached from the leg 68. The tray 60 may be used while connected to the leg 68 or may be insertably detached for use while unconnected from the leg 68.

The tray 60 of this embodiment has the same features mentioned above. Specifically the fold-up tray 60 includes the sections 32, 34 and the living hinge 36.

While particular embodiments of the invention have been shown and described, numerous variations and alternative embodiments will occur to those skilled in the art. Accordingly, it is intended that the invention be limited only in terms of the appended claims.

What is claimed is:

1. A fold-up tray for a vehicle comprising:
a top surface;
a first section that includes a first portion of the top surface;
a second section that includes a second portion of the top surface; and
a hinge, wherein the hinge couples said first section and said second section, whereby an increased working surface is provided by both portions when said tray is unfolded and a stowable working surface is provided by both portions when said tray is folded.

2. The fold-up tray in claim 1 further comprising a clip coupled to one of the sections, wherein the clip releasably engages said section, whereby papers or the like may be releasably retained by said clip.

3. The fold-up tray in claim 2, wherein said clip is a clipboard clip.

4. The fold-up tray in claim 3, wherein said clipboard clip includes a clip wire, a spring coupled to said clip wire, and a housing supportively receiving said spring and said wire, wherein said spring maintains a rotational load between said clip wire and said housing.

5. The fold-up tray in claim 1, wherein said hinge is a living hinge.

6. The fold-up tray in claim 5 wherein said living hinge, said first section and said second section are formed from a unitary piece of material.

7. The fold-up tray in claim 6 wherein the unitary piece of material is plastic.

8. The fold-up tray in claim 5 wherein said living hinge comprises a piano hinge coupled to said first section and said second section, and a material strip coupled to said top surface and said piano hinge, said material strip spans said piano hinge coupling said first section and said second section, whereby a substantially continuous top surface is provide when the tray is unfolded.

9. The fold-up tray in claim 1 further comprising a slide rail coupled to one of the sections, whereby said slide rail is selectively attachable to an arm or armrest of a vehicle.

10. A stowable tray assembly for a vehicle comprising:
a fold-up tray, said fold-up tray includes a top surface, a first section that includes a first portion of the top surface, a second section that includes a second portion of the top surface, and a hinge, wherein the hinge couples said first section and said second section, wherein an increased working surface is provided by both portions when said tray is unfolded and a stowable working surface is provided by both portions when said tray is folded; and
a panel for releasably receiving said fold-up tray.

11. The stowable tray assembly in claim 10 wherein said panel is a bolster area, said bolster area includes a storage location for stowing said fold-up tray.

12. The stowable tray assembly in claim 11 wherein said storage location is recessed within said bolster area and includes a first side lip, a second side lip, a back wall separating said side lips and a lower lip, wherein the outer edges of said fold-up tray are releasably retained between said side lips, and said fold-up tray is stowable against said back wall of said storage location.

13. The stowable tray assembly in claim 11 wherein said storage location further includes a recess, whereby a user may removably access said tray by said recess in said storage location.

14. The stowable tray assembly in claim 11 wherein said fold-up tray may be releasably retained by a snap-fit engagement in said storage location.

15. The stowable tray assembly in claim 11 wherein said storage location includes at least one first hook oppositely opposing at least one second hook, both hooks coupled to said bolster area, wherein the outer edges of said fold-up tray are releasably retained between said hooks.

16. The stowable tray assembly in claim 11 wherein said storage location includes an arm rest and an arm positionably coupled to said arm rest, wherein said arm may releasably receive said fold-up tray, said arm having a stowed position and a deployed position.

17. A stowable tray assembly for a vehicle comprising:
a fold-up tray, said fold-up tray includes a top surface, a first section that includes a first portion of the top surface, a second section that includes a second portion of the top surface, and a hinge, wherein the hinge couples said first section and said second section, wherein an increased working surface is provided by both portions when said tray is unfolded and a stowable working surface is provided by both portions when said tray is folded;
a slide rail coupled to one of said portions of said fold-up tray;
a panel; and
an arm positionably coupled to said panel, said arm includes a top edge and a slide slot coupled within said top edge, wherein said slide slot of said arm is coupled to said slide rail of said fold-up tray.

18. The stowable tray assembly in claim 17 further comprising a securing mechanism positionably coupled to said panel and said arm, wherein said arm has a stowed position and a deployed position, and said arm is securable in one of said positions by said securing mechanism.

19. The stowable tray assembly in claim 17 wherein said fold-up tray is positionably adjustable in said arm in the fore or aft direction.

20. The stowable tray assembly in claim 17 wherein said fold-up tray is releasably attachable to said arm, whereby a user may use said fold-up tray independently of said arm and may reattach said fold-up tray to said arm for stowage.
